(19) United States
(12) Patent Application Publication
(10) Pub. No.: US 2012/0139947 A1
(43) Pub. Date: Jun. 7, 2012

(54) INFORMATION PROCESSOR, INFORMATION PROCESSING METHOD AND PROGRAM

(75) Inventors: Koichiro Kishima, Kanagawa (JP); Masashi Kimoto, Tokyo (JP)

(73) Assignee: Sony Corporation, Tokyo (JP)

(21) Appl. No.: 13/305,052

(22) Filed: Nov. 28, 2011

(30) Foreign Application Priority Data
Dec. 2, 2010 (JP) P2010-268949

(51) Int. Cl. G09G 5/00

(52) U.S. Cl. 345/660

(57) ABSTRACT

Disclosed herein is an information processor including: a display setup information acquisition section adapted to acquire, as display setup information, information about the layout of a plurality of displays in a display space formed by arranging the plurality of displays adjacently; and an image adjustment section adapted to adjust, based on the display setup information, at least either the position or size of a subimage so as to ensure that the subimage does not spread across a boundary between the displays when an image including a main image and the subimage smaller than the main image is displayed in the display space.

### BACKGROUND

The present disclosure relates to an information processor, information processing method and program capable of displaying, in a display space made up of a plurality of displays and whose area is divided by physical lines, an image visually divided into a plurality of areas.

In medical, pathological and other sectors, a digital pathology technique has been proposed that is designed to digitize an image of a live cell, tissue, organ and so on obtained by an optical microscope so as to allow for medical doctors, pathologists and others to test the tissue and diagnose a patient based on the digital image.

In the method described in Japanese Patent Laid-Open No. 2009-37250 (hereinafter referred to as Patent Document 1), for example, an image obtained by an optical microscope is digitized by a video camcorder incorporating a CCD (Charge Coupled Device), and the digital signal thereof is fed to a control computer system for visualization on a monitor. The pathologist (user) proceeds with testing or other tasks while watching the image on the monitor (refer to paragraphs [0027] and [0028] and FIG. 5 in Patent Document 1).

In the digital pathology technique, a microscopic image of interest (hereinafter a main image) and a low-resolution image (hereinafter a navigation image) subject to various operations (for navigation) obtained by reducing the main image to a similar shape may be displayed. A navigation frame appears superimposed on the navigation image so that the area currently displayed as a main image is indicated by enclosing this area with the navigation frame. The spatial conditions (e.g. enlargement ratio and display area) of the main image to be displayed can be specified by manipulating the navigation frame in the navigation image. Further, a sequence of a plurality of thumbnail images of a main image to be displayed (hereinafter a slide list) and a single main image may be displayed side by side. This slide list is used to select a main image to be displayed itself. On the other hand, a main image and other image serving as a reference image (e.g., a slide adjacent to a slide to be observed, image stained by other method or image of a similar case) may be displayed side by side. Further, a text display area adapted to display text entered by the user by using, for example, a keyboard and a main image may be displayed side by side.

As described above, amid the growing trend of information being displayed as a result of proliferation of digital pathology, a technique has been proposed that is designed to widen the display screen by using, for example, a plurality of displays. For example, “Virtual reality Powerwall versus conventional microscope for viewing pathology slides: an experimental comparison,” Darren Treanor, Naomi Jordan-Owers, John Hodrien, Jason Wood, Phil Quirke, and Roy A Ruddle, Histopathology 2009, 55, 294-300 (hereinafter referred to as Non-Patent Document 1) shows an example in which a main image and a low-resolution navigation image, obtained by reducing the main image, appear in a display space made up of 28 displays (four down by seven across). A navigation frame appears superimposed on the navigation image so that the area currently displayed as the main image is indicated by enclosing this area with the navigation frame (refer, for example, to FIG. 1 in Non-Patent Document 1).

### SUMMARY

However, if a screen including a navigation image, slide list or text display area is enlarged ‘as-is’ without changing the layout intended to display this screen on a single display, and if this screen is displayed on a display space made up of a plurality of displays, inconvenience may arise due to the presence of a display frame.

For example, if one of navigation images or one of images in a slide list (hereinafter a subimage) appears to spread across a display frame (refer, for example, to FIG. 1 in Non-Patent Document 1), the subimage is difficult to see. The reason for this is that a subimage is originally smaller and less sharp than its main image, and that if the subimage appears to spread across a frame, the subimage which is already small is divided by the frame, thus resulting in part of the subimage extending into the adjacent display and making this portion difficult to see.

Further, if a navigation frame appears to spread across a display frame (refer, for example, to FIG. 1 in Non-Patent Document 1), the navigation frame is difficult to manipulate and see when the spatial conditions (e.g. enlargement ratio and display area) of the main image to be displayed are specified by manipulating the navigation frame in the navigation image.

Still further, if a text display area appears to spread across a display frame, the text display area becomes larger, thus squeezing the display area of the main image or making it difficult to enter text because of the text display area spreading across a plurality of displays.

A possible countermeasure against this problem would be to enter display information in advance using an application and have ready display patterns for a plurality of displays. However, it is difficult for this approach to handle cases in which the user increases the number of pixels of the displays or the number of displays. Further, if the user is allowed to update information as appropriate when a change is made to the displays, it is difficult to respond to an error in entering the number of pixels. Still further, it is difficult to control display information from a pathological image display application.

In light of the foregoing, it is desirable to provide an information processor, information processing method and program capable of displaying, in a display space made up of a plurality of displays arranged side by side, a small low-resolution image in an easy-to-see manner for the user.

According to an embodiment of the present disclosure, there is provided an information processor that includes a display setup information acquisition section and an image adjustment section.

The display setup information acquisition section acquires, as display setup information, information about the layout of a plurality of displays in a display space formed by arranging the plurality of displays side by side.

The image adjustment section adjusts, based on the display setup information, at least either the position or size of a subimage so as to ensure that the subimage does not spread across a boundary between the displays when an image including a main image and the subimage smaller than the main image is displayed in the display space.

As a result, even if the number of displays making up the single display space is changed at will by the user, it is possible to set the layout of the subimage display area according to the layout of the displays to ensure that the subimage is not divided by a boundary between the displays according to the layout. As a result, the impact of boundaries between the displays on the visibility can be suppressed. That is, this eliminates the inconvenience of part of the subimage extending into the adjacent display and making this portion difficult to see.

The image adjustment section may display a frame adapted to indicate the display area of the main image in a manner superimposed on the subimage.

The subimage appears in such a manner as not to spread across a boundary between the displays, and, therefore, the frame displayed in a manner superimposed on the subimage also appears in such a manner as not to spread across a boundary between the displays. This eliminates the inconvenience of the frame becoming difficult to manipulate and see when the spatial conditions (e.g. enlargement ratio and display area) of the main image to be displayed are specified by manipulating the frame in the subimage.

When the plurality of main images are displayed side by side, the image adjustment section may adjust, based on the display setup information, at least either the positions or sizes of the plurality of main images so that at least one of boundaries between the plurality of main images overlaps the boundary between the displays.

This contributes to a smaller number of the main images divided by the frame, thus eliminating the inconvenience of part of the main image extending into the adjacent display and making this portion difficult to see.

When the plurality of subimages, each associated with one of the plurality of main images, are displayed, the image adjustment section may adjust, based on the display setup information, at least the position or size of the subimage so that one side of at least one of the plurality of subimages overlaps the boundary.

This eliminates the inconvenience of part of the small subimage extending into the adjacent display and making this portion difficult to see.

When the plurality of subimages are arranged in a row and displayed as a subimage sequence, the image adjustment section may adjust, based on the display setup information, at least either the positions or sizes of the plurality of subimages so that at least one of the boundaries between the plurality of subimages overlaps the boundary between the displays.

This eliminates the inconvenience of the subimage becoming difficult to manipulate and see when the subimage is selected and manipulated to select the main image to be displayed.

When a text display area is secured to display text information in the display space, the image adjustment section may adjust, based on the display setup information, the position of the text display area so as to ensure that the text display area does not spread across the boundary between the displays.

This eliminates the inconvenience of the text display area becoming larger and squeezing the display area of the main image as a result of the text display area spreading across the boundary, or this eliminates the difficulty in entering text as a result of the text display area spreading across a plurality of displays.

According to another embodiment of the present disclosure, there is provided an information processing method that acquires information about the layout of a plurality of displays in a display space formed by arranging the plurality of displays side by side.

The information processing method adjusts at least either the position or size of a subimage based on the display setup information so as to ensure that the subimage does not spread across a boundary between the displays when an image including a main image and the subimage smaller than the main image is displayed in the display space.

According to a further embodiment of the present disclosure, there is provided a program that allows an information processor to function as a display setup information acquisition section and an image adjustment section.

The display setup information acquisition section acquires information about the layout of a plurality of displays in a display space formed by arranging the plurality of displays side by side.

The image adjustment section adjusts, based on the display setup information, at least either the position or size of a subimage so as to ensure that the subimage does not spread across a boundary between the displays when an image including a main image and the subimage smaller than the main image is displayed in the display space.

The present disclosure displays, in a display space made up of a plurality of displays arranged side by side, a small low-resolution image in an easy-to-see manner for the user.

### BRIEF DESCRIPTION OF THE DRAWINGS

FIG. 1 is a block diagram illustrating an information processing system including at least an information processor according to an embodiment of the present disclosure;

FIG. 2 is a block diagram illustrating the relationship between a viewer application, display driver setup program, display driver and display setup information file;

FIG. 3 is a flowchart illustrating the operation adapted to acquire display setup information;

FIG. 4 is a diagram describing an image display and manipulation environment provided by the viewer application;

FIG. 5 is a flowchart illustrating image adjustment;

FIG. 6 is a diagram illustrating an image in which a thumbnail image spreads across a boundary between displays;

FIG. 7 is a diagram illustrating an image after adjustment of the images in a slide list;

FIG. 8 is a diagram illustrating an image after adjustment of the image in a text display area;

FIG. 9 is a diagram illustrating an image after adjustment of a navigation image;

FIG. 10 is a diagram illustrating an image after adjustment of a main image;

FIG. 11 is a diagram illustrating an image after adjustment of a reference image;

FIG. 12 is a diagram illustrating an example in which the number of the reference images has been increased;

FIG. 13 is another diagram illustrating an example in which the number of the reference images has been increased; and

FIG. 14 is still another diagram illustrating an example in which the number of the reference images has been increased.

### DETAILED DESCRIPTION OF THE PREFERRED EMBODIMENT

### [Outline of the Present Embodiment]

The present embodiment relates to an information processor capable of displaying, in a display space made up of a plurality of displays assembled vertically and horizontally, a plurality of images each in an area partitioned from other areas.

An image displayed by this information processor mainly includes at least one or more high-resolution (microscopic) images to be observed (hereinafter main images) and subimages, each associated with one of the main images. The subimages are, for example, subject to various operations (for navigation). That is, each of the subimages is a bird's eye image of its main image as a whole and designed to present, to the user, the position, in the main image as a whole, of the portion displayed on a main image display area as a result of selection, enlargement or reduction of a desired portion. Each of the subimages is smaller than its main image. An area having a given positional relationship with its main image is assigned as a subimage display area so that the user observing the main image can smoothly switch from observation of the main image over to performing an operation adapted to change the display status of the main image. For example, a rectangular area at the top right corner of the main image display area is assigned as a subimage display area so that the user can intuitively understand which subimage is accessory to which main image. Two such combinations of a main image and subimage are arranged side by side, for example, when two images to be observed are compared.

If not only a main image and subimage but also two combinations of a main image and subimage are displayed in a display space made up of a plurality of displays assembled vertically and horizontally, and if the layout of the plurality of displays is fixed, it is possible to keep the impact of boundaries between the displays on the visibility to a minimum by setting the layout of the display areas of the images so as to ensure that none of the main images and subimages spread across any of the boundaries between the displays. However, this is difficult to achieve if the number of displays making up the single display space can be changed at will by the user.

Therefore, the present embodiment provides an information processor that includes two sections, one adapted to generate, at any time, information (display setup information) as to how each of the displays is configured and how the displays are assembled to make up a single display space, and another adapted to adjust the layout of the display areas of the main images and subimages in the viewer based on the display setup information generated by the above section.

In the information processor according to the present embodiment, it is determined, based on the roles played by the main image and subimage, which of the display areas of the main image and subimage is more preferentially prevented from spreading across a boundary between the displays. That is, although ideally neither the main image nor the subimage should spread across a boundary between the displays, it is basically necessary for the viewer to assign as high a resolution as possible to the display of the main image. Therefore, it is practically difficult to set the display areas so that the main image does not spread across any of the boundaries between the displays. Moreover, even if the main image appears divided by a boundary between the displays, the possible adverse impact thereof on the observation of the main image is slight. In contrast, if divided by a boundary between the displays, the subimage which is significantly smaller than the main image appears further divided into a plurality of areas, possibly resulting in degraded visibility and operability. In the information processor according to the present embodiment, therefore, the layout adjustment section generates, based on the display setup information, the layout of the display areas of the main image and subimage in the viewer so as to ensure that at least the subimage is not divided by a boundary between the displays.

A detailed description will be given below of the information processor according to the present embodiment with reference to the accompanying drawings.

### [Configuration of the Information Processing System]

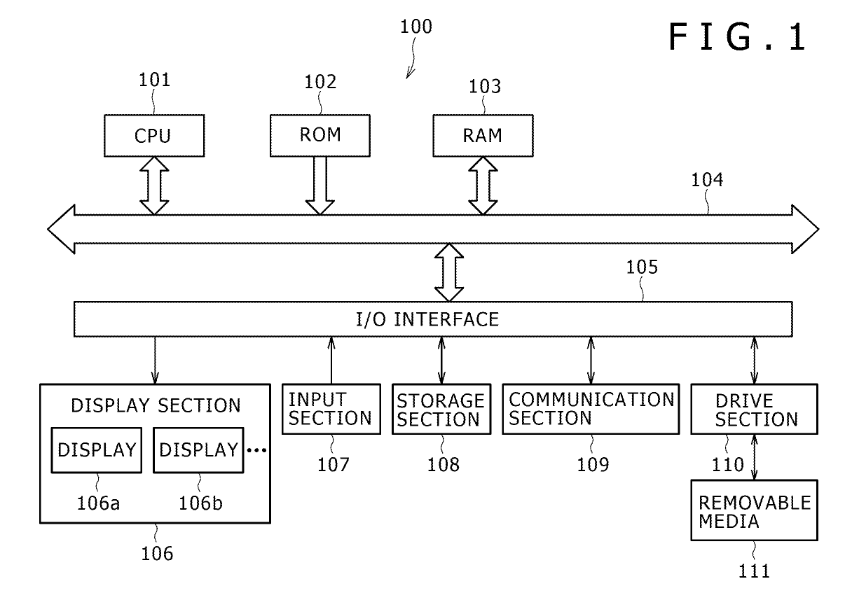

FIG. 1 is a block diagram illustrating an information processing system including at least the information processor according to an embodiment of the present disclosure.

A PC (Personal Computer) 100, for example, is used as an information processor. The PC 100 includes a CPU (Central Processing Unit) 101, ROM (Read Only Memory) 102, RAM (Random Access Memory) 103, I/O interface 105 and bus 104. The bus 104 connects the CPU 101, ROM 102 and RAM 103 to the I/O interface 105.

A display section 106, input section 107, storage section 108, communication section 109 and drive section 110 are connected to the I/O interface 105.

The display section 106 includes a plurality of displays 106a, 106b and so on that are arranged to be adjacent to each other. The display section 106 can display an image on the plurality of displays 106a, 106b and so on that are arranged to be adjacent to each other in such a manner as to form a display space. Each of the plurality of displays is a liquid crystal, EL (Electro-Luminescence), CRT (Cathode Ray Tube) or other display device. These displays are identical in performance and size. The display section 106 includes, for example, four (two down by two across), six (two down by three across) or 15 (three down by five across) displays. However, the display section 106 is not limited thereto.

The input section 107 includes operating devices such as a mouse, a pointing device, a keyboard and a touch panel. If the input section 107 includes a touch panel, this touch panel can be integral with the display section 106.

The storage section 108 is a non-volatile memory and a solid-state memory such as an HDD (Hard Disk Drive), an SSD (Solid State Drive) or a flash memory. Image data obtained by an unshown optical microscope is stored mainly in the storage section 108 of the PC 100.

The drive section 110 is a device capable of driving a removable recording media 111 such as an optical recording media, a floppy (registered trademark) disk, a magnetic recording tape or a flash memory. In contrast, the storage section 108 is often used as a device preinstalled in the PC 100 adapted to drive mainly non-removable storage media.

The communication section 109 is a communication device such as a modem or a router adapted to communicate with other device that can connect to a network such as LAN (Local Area Network) or WAN (Wide Area Network). The communication section 109 may communicate in a wired or wireless fashion. The communication section 109 is often used as a device separate from the PC 100.

The ROM 102 is a read-only memory that permanently stores programs and data for software processing performed by the PC 100. It should be noted that the programs may be stored in the storage section 108.

The RAM 103 (main memory) is a writable volatile memory used to load program code executed by the CPU 101 or write work data of the programs.

The CPU 101 exercises comprehensive control over the different sections of the PC 100 and controls the exchange of data between these different sections. The CPU 101 loads, interprets and executes a necessary program such as an image viewer (hereinafter a viewer) application from the ROM 102 into the RAM 103 for software processing by the PC 100.

### [Operation of the Information Processor]

A description will be given next of the operation of the information processor configured as described above. The operation will be described in the following order.

### 1. Acquisition of Display Setup Information

### 2. Image Adjustment

### [1. Acquisition of Display Setup Information]

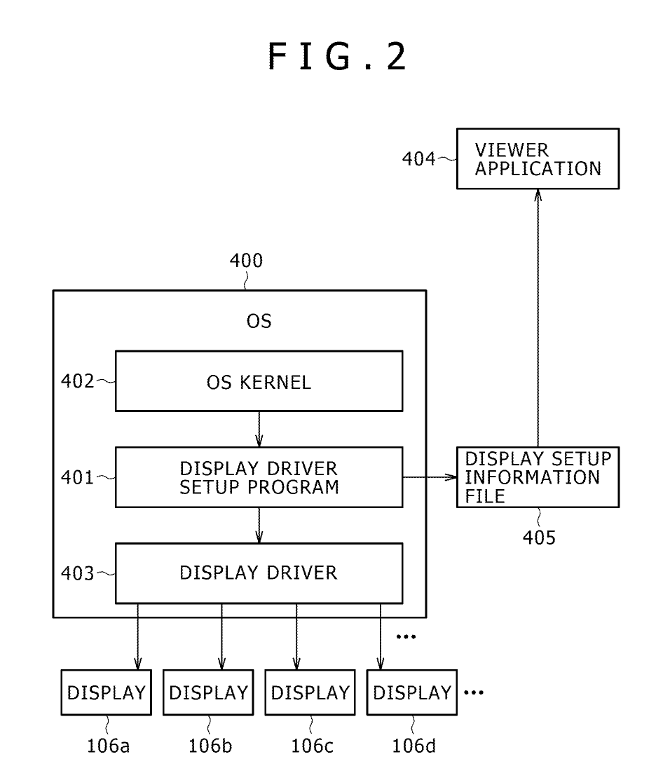

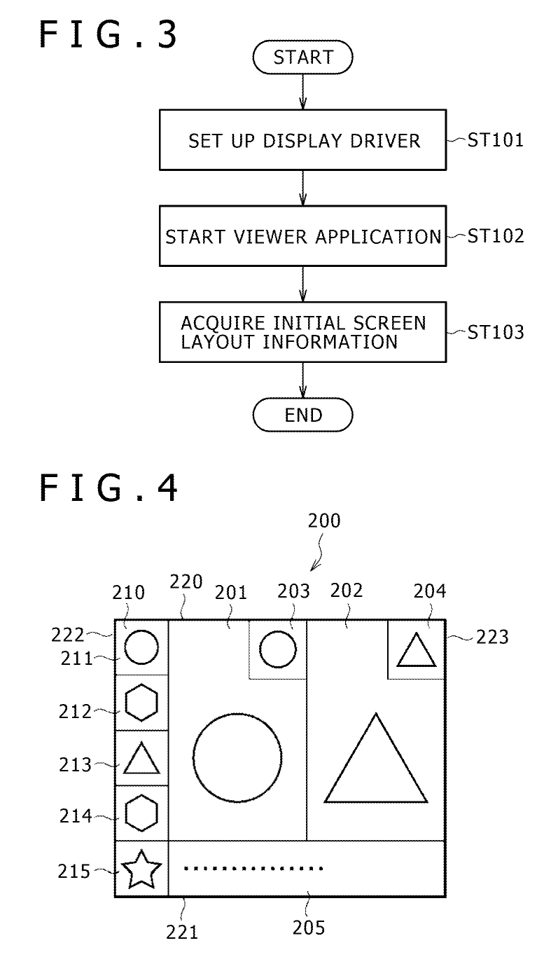

FIG. 2 is a block diagram illustrating the relationship between a viewer application, a display driver setup program, a display driver and a display setup information file. FIG. 3 is a flowchart illustrating the operation adapted to acquire display setup information.

A display driver setup program 401 generates display setup information as to how each of the displays 106a, 106b and so on is configured and how the displays 106a, 106b and so on are assembled to make up a single display space. The display driver setup program 401 is invoked by an OS kernel 402 when a change is made such as addition or deletion of a display or when an OS (Operating System) 400 starts. The display driver setup program 401 acquires information including the resolution of the connected displays 106a, 106b and so on and the number (number of displays across and the number down) by communicating with a display driver 403. The display driver setup program 401 creates a display setup information file 405 based on these pieces of information, storing the file to a path that can be read by a viewer application 404 (step ST101). Display setup information includes the number of displays, resolution of the overall display space, positions of the boundaries between the displays in the whole display space and so on.

When started, the viewer application 404 reads the display setup information file 405 and stores the file to the environment file of the viewer application 404 secured in the RAM 103 (main memory) (step ST102). The environment file of the viewer application 404 is a file that stores various operating conditions of the viewer application 404 as environment setting data. The environment file also stores information about the initial screen layout. The initial screen layout information defines the configuration of the initial screen displayed when the viewer application 404 is started. Each time the viewer application 404 is started, the viewer application 404 reads the display setup information file 405 and adds the content of the display setup information file to the environment file.

The viewer application 404 reads initial screen layout information and display setup information from the environment file, generating, based on these pieces of information, an initial adjustment screen suited to the display configuration (step ST103).

A description will be given next of the image display and manipulation environment provided by the viewer application 404.

FIG. 4 is a diagram describing the image display and manipulation environment provided by the viewer application 404. FIG. 4 does not show the relationship with a single physical display space made up a plurality of displays assembled together.

Among the elements of the image display and manipulation environment provided by the viewer application 404 based on the initial screen layout information are as follows:

1. Main image area

2. Navigation image

3. Slide list

4. Text display area

A description will be given below of each of these elements.

### 1. Main Image Area

The main image area is assigned as an area adapted to display a high-resolution (microscopic) image to be observed. It is basically necessary for the viewer application 404 to assign as high a resolution as possible to the display of a main image 201. The viewer application 404 loads the main image 201 from the storage section 108 for display.

### 2. Navigation Image

The viewer application 404 can display not only the main image 201 but also a low-resolution image subject to various operations (for navigation) obtained by reducing the main image to a similar shape (hereinafter a navigation image). A navigation frame (not shown) appears superimposed on a navigation image 203 so that the area currently displayed as the main image 201 is indicated by enclosing this area with the navigation frame. That is, the navigation image 203 is a bird's eye image of the main image 201 as a whole and designed to present, to the user, the position, in the main image 201 as a whole, of the portion displayed on the display area of the main image 201 as a result of selection, enlargement or reduction of a desired portion. The navigation image 203 is smaller than the main image 201, and an area having a given positional relationship with the main image 201 is assigned as a display area of the navigation image 203 so that the user observing the main image 201 can smoothly switch from observation of the main image 201 over to performing an operation adapted to change the display status of the main image 201. For example, a rectangular area at the top right corner of the display area of the main image 201 is assigned as a display area of the navigation image 203 so that the user can intuitively understand that the navigation image 203 is accessory to the main image 201. The spatial conditions (e.g. enlargement ratio and display area) of the main image 201 to be displayed can be specified by manipulating the navigation frame in the navigation image 203. If the navigation frame included in the navigation image 203 is moved, enlarged or reduced, for example, as a result of dragging of the mouse (input section 107) by the user, the viewer application 404 reads, from the storage section 108, the main image 201 associated with the display area of the navigation image 203 which is in turn associated with the navigation frame that has been moved, enlarged or reduced, thus displaying the main image 201.

Further, the viewer application 404 can display two combinations of a main image and subimage side by side, for example, when two images to be observed are compared. Of two main images displayed side by side, the main image 201 is used as a main target image, and a main image 202 is used, for example, as a reference for observation of the main image 201, i.e., the main target image. The main image 202 will be referred to as a “reference image.” Here, the reference image 202 is a slide adjacent to the slide of the main image 201, i.e., the main target image to be observed, image stained by other method (e.g., hematoxylin and eosin stain (HE stain), DAPI stain) or image of a similar case.

### 3. Slide List

The viewer application 404 can also display a thumbnail image sequence (hereinafter a slide list) in which low-resolution thumbnail images 211 to 215, obtained by reducing a plurality of main images to be displayed to the same size, are arranged in a row. When the user selects one of the plurality of thumbnail images 211 to 215 included in a slide list 210, for example, by pointing and mouse clicking, the viewer application 404 reads, from the storage section 108, the main image 201 associated with the selected thumbnail image, thus displaying the main image 201.

### 4. Text Display Area

The viewer application 404 can also display a text display area adapted to display text entered by the user by using a keyboard and the like.

The image display and manipulation environment shown in FIG. 4 includes the main image 201, the navigation image 203 associated with the main image 201, the reference image 202, a navigation image 204 associated with the reference image 202, the slide list 210 made up of the five thumbnail images 211 to 215 and a text display area 205. Here, the five thumbnail images 211 to 215 are aligned vertically in a row extending from a top side 220 to a bottom side 221 along a left side 222 of the screen. The text display area 205 extends from the right edge of the lowermost thumbnail image 215 in the slide list 210 to a right side 223 of the screen and arranged along the bottom side 221. The main image 201 and reference image 202 are identical in size and arranged side by side in an area partitioned by the top and bottom sides 220 and 221 of the screen, the slide list 210 and text display area 205. The navigation image 203 is arranged in a rectangular area at the top right corner of the associated main image 201. On the other hand, the navigation image 204 is arranged in a rectangular area at the top right corner of the associated reference image 202.

As described above, the image formed based on initial screen layout information is configured in consideration of the balance of the image to be displayed in a single display space as a whole. However, if the image formed in consideration of the balance thereof is enlarged without changing the balance and displayed in a display space made up of a plurality of displays, inconvenience may arise due to the presence of a display frame. As an example of possible inconvenience, any of the navigation images 203 and 204 and the thumbnail images 211 to 215 may appear to spread across a display frame. In order to remedy this inconvenience, the above acquisition of the display setup information is followed by the image adjustment.

A description will be given below of the image adjustment performed on the PC 100 as a result of the execution of the viewer application 404 by the CPU 101.

### [2. Image Adjustment]

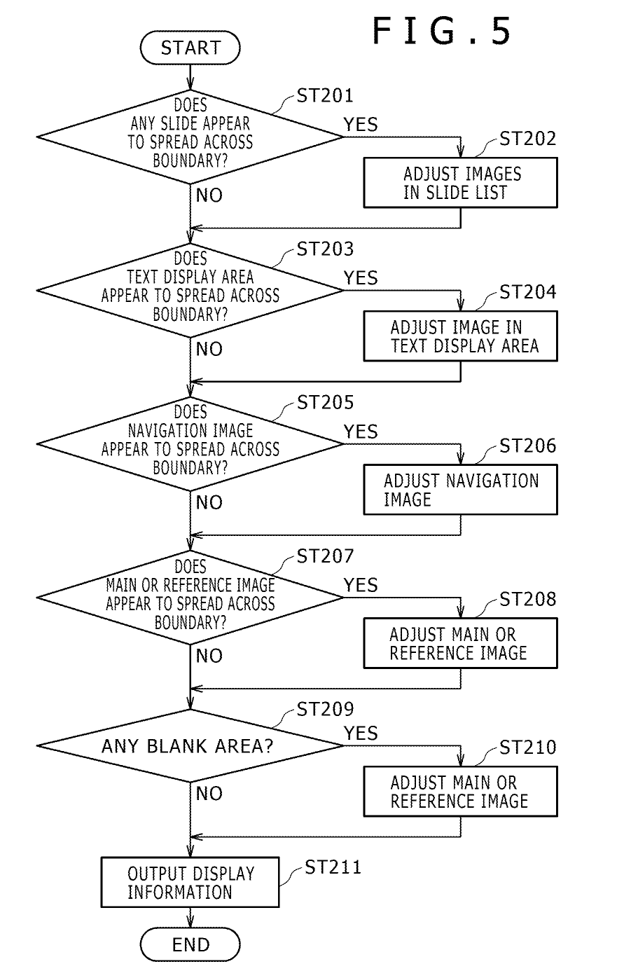

FIG. 5 is a flowchart illustrating the image adjustment.

First, using the viewer application 404, the CPU 101 determines, based on the initial screen layout information and display setup information stored in the environment file, whether any of the thumbnail images in the slide list spreads across a boundary between the displays (step ST201). When determining that any of the thumbnail images spreads across a boundary between the displays (Yes in step ST201), the CPU 101 adjusts the images in the slide list (step ST202). It should be noted that the term “boundary” in the present embodiment refers to a boundary between two adjacent displays and a concept including a frame (bezel) of a display.

A description will be given here of the adjustment of the images in the slide list.

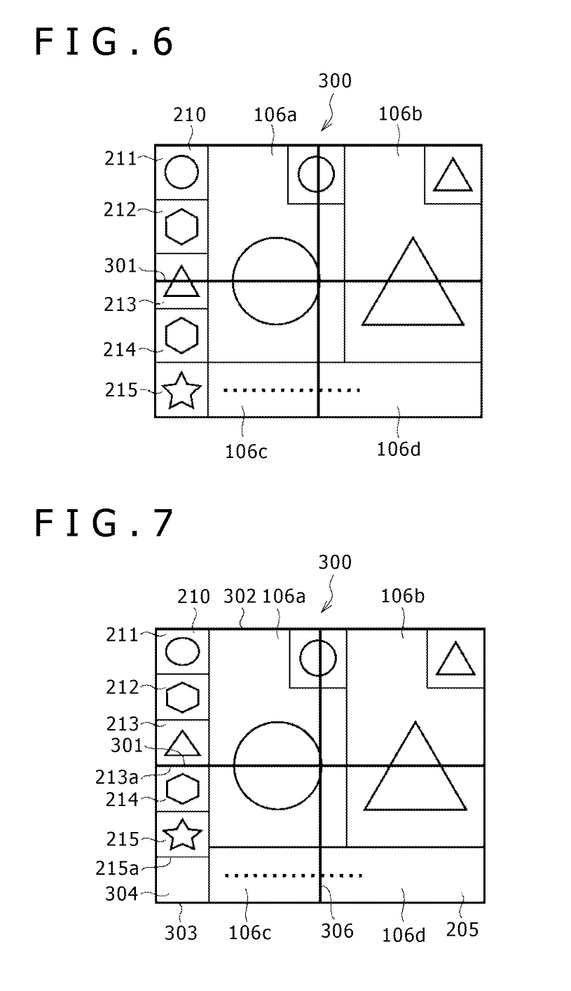

FIG. 6 is a diagram illustrating an image in which a thumbnail image spreads across a boundary between displays.

FIG. 6 illustrates an image formed, based on the initial screen layout information, in a display space 300 made up of four (two down by two across) displays 106a (top left), 106b (top right), 106c (bottom left) and 106d (bottom right) arranged to be adjacent to each other. In this initial screen layout, the thumbnail image 213 in the slide list 210 appears to spread across a boundary 301 between the displays 106a and 106c. In this case, the CPU 101 determines that the thumbnail image 213 spreads across the boundary 301. As a result, the CPU 101 adjusts the images in the slide list 210.

FIG. 7 is a diagram illustrating the image after adjustment of the images in the slide list.

The CPU 101 reduces the sizes (heights) of the thumbnail images 211 to 215 by the same magnification ratio so that a bottom edge 213a of the thumbnail image 213 that appears to spread across the boundary 301 between the displays 106a and 106c overlaps the boundary 301. As a result, the thumbnail images 211 to 213 are aligned vertically in a row extending from a top edge 302 of the display 106a to the boundary 301. As a continuation of the above images, the thumbnail images 214 and 215 are arranged to fit into the display 106c from the boundary 301. This leads to a blank area 304 between a bottom edge 215a of the thumbnail image 215 and a bottom edge 303 of the display 106c. The term “blank area” here refers to an area having nothing to display as a result of the image adjustment.

It should be noted that if two or more thumbnail images spread across boundaries between the displays when there are many displays, the CPU 101 repeats the above image adjustment. The adjustment described below is the same in this regard.

Referring back to FIG. 5, after adjusting the images in the slide list (step ST202) or determining that none of the thumbnail images spread across a boundary between the displays (No in step ST201), the CPU 101 determines whether the text display area spreads across a boundary between the displays (step ST203). When determining that the text display area spreads across a boundary between the displays (Yes in step ST203), the CPU 101 adjusts the image in the text display area (step ST204).

A description will be given here of the image adjustment in the text display area.

FIG. 7 described above illustrates an image in which the text display area spreads across a boundary between the displays.

On this screen, the text display area 205 appears to spread across a boundary 306 between the displays 106c and 106d. In this case, the CPU 101 determines that the text display area 205 spreads across the boundary 306 between the displays. Therefore, the CPU 101 adjusts the image in the text display area 205.

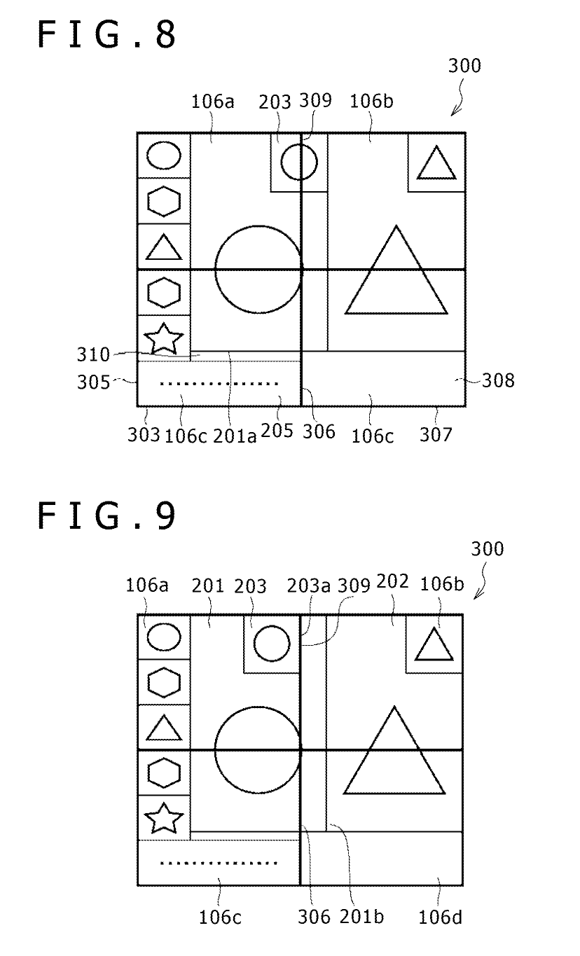

FIG. 8 is a diagram illustrating the image after adjustment of the image in the text display area.

The CPU 101 selects, as a destination of the text display area 205, an area sized, for example, about 300 pixels down by about 700 to 1500 pixels across, based on the display setup information, thus adjusting the image in the text display area 205. The CPU 101 adjusts the image in the text display area 205, for example, so that the following conditions are met, namely, that the text display area 205 fits into a single display (does not spread across a boundary), that the text display area 205 is arranged along the bottom edge of the display space 300, and that the text display area 205 fills the blank area 304 produced as a result of the image adjustment of the slide list 210. For example, the CPU 101 arranges the text display area 205 along the bottom edge 303 of the display 106c in such a manner that the text display area 205 extends from a left edge 305 of the display 106c to the boundary 306 between the displays 106c and 106d. As a result, a blank area 308 is produced above a bottom edge 307 of the display 106d where the text display area 205 should have been arranged based on the initial screen layout information. In addition, a blank area 310 is produced between a bottom edge 201a of the main image 201 and the text display area 205.

Referring back to FIG. 5, after adjusting the image in the text display area (step ST204) or determining that the text display area does not spread across a boundary between the displays (No in step ST203), the CPU 101 determines whether any of the navigation images spreads across a boundary between the displays (step ST205). When determining that any of the navigation images spreads across a boundary between the displays (Yes in step ST205), the CPU 101 adjusts the navigation image (step ST206).

A description will be given here of the adjustment of a navigation image.

FIG. 8 described above illustrates an image in which a navigation image spreads across a boundary between the displays.

On this screen, the navigation image 203 appears to spread across a boundary 309 between the displays 106a and 106b. In this case, the CPU 101 determines that the navigation image 203 spreads across the boundary 309 between the displays. Therefore, the CPU 101 adjusts the navigation image 203.

FIG. 9 is a diagram illustrating an image after adjustment of the navigation image.

The CPU 101 moves the navigation image 203 based on the display setup information so that the right or left edge (a right edge 203a in this example) of the navigation image 203 appearing to spread across the boundary 309 between the displays 106a and 106b overlaps the boundary 309.

Referring back to FIG. 5, after adjusting the navigation image (step ST206) or determining that none of the navigation images spread across a boundary between the displays (No in step ST205), the CPU 101 determines whether the main or reference image associated with the adjusted navigation image spreads across a boundary between the displays (step ST207). When determining that the main or reference image spreads across a boundary between the displays (Yes in step ST207), the CPU 101 adjusts the main or reference image (step ST208).

A description will be given here of the adjustment of the main or reference image.

FIG. 9 described above illustrates an image in which the main image associated with the adjusted navigation image spreads across a boundary between the displays.

On this screen, the main image 201 associated with the adjusted navigation image 203 appears to spread across the boundary 309 between the displays 106a and 106b and the boundary 306 between the displays 106c and 106d. In this case, the CPU 101 determines that the main image 201 spreads across the boundaries 306 and 309 between the displays. Therefore, the CPU 101 adjusts the main image 201.

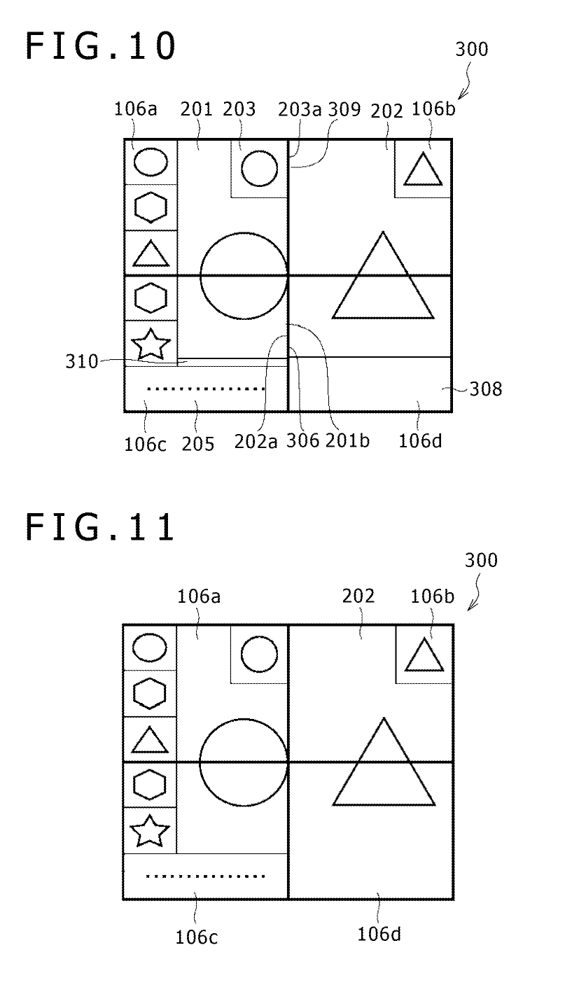

FIG. 10 is a diagram illustrating an image after adjustment of the main image.

The CPU 101 determines, based on the display setup information, the distance between each of the boundaries 306 and 309 and the edge (a right edge 201b in this example) of the main image 201 closest to the boundaries 306 and 309. When determining that the distance between each of the boundaries 306 and 309 and the right edge 201b of the main image 201 is equal to a given value (e.g., 100 pixels) or less, the CPU 101 moves the right edge 201b in such a manner as to reduce the horizontal width of the main image 201 so that the right edge 201b of the main image 201 overlaps the boundaries 306 and 309. Simultaneously with the movement of the right edge 201b of the main image 201, the CPU 101 moves a left edge 202a of the reference image 202 in such a manner as to increase the horizontal width of the reference image 202 so that the left edge 202a of the reference image 202, arranged to be adjacent to the right edge 201b of the main image 201, overlaps the boundaries 306 and 309.

Referring back to FIG. 5, after adjusting the main image or reference image (step ST208) or determining that neither the main image nor the reference image spreads across a boundary between the displays (No in step ST207), the CPU 101 determines whether there is any blank area in the display space 300 (step ST209). When determining that there is a blank area (Yes in step ST209), the CPU 101 adjusts the main or reference image (step ST210).

A description will be given here of the adjustment of the main or reference image.

FIG. 10 described above illustrates an image in which a blank area has been produced as a result of the adjustment of the text display area.

On this screen, there is the blank area 308 adjacent to the text display area 205 and the reference image 202. Further, there is the blank area 310 adjacent to the text display area 205 and the main image 201. In this case, the CPU 101 determines that there are the blank areas 308 and 310. Therefore, the CPU 101 adjusts the main and reference images 201 and 202.

FIG. 11 is a diagram illustrating an image after adjustment of the reference image.

The CPU 101 determines, based on the display setup information, whether the main or reference image (main image 201 in this example) is adjacent to the blank area 310. When determining that the main image 201 is adjacent to the blank area 310, the CPU 101 enlarges the main image 201 in such a manner as to fill the blank area 310. Then, the CPU 101 determines, based on the display setup information, whether the main or reference image (reference image 202 in this example) is adjacent to the blank area 308. When determining that the reference image 202 is adjacent to the blank area 308, the CPU 101 enlarges the reference image 202 in such a manner as to fill the blank area 308.

It should be noted that when determining, as a result of the image adjustment in step ST210, that the main image 201 has become smaller than the reference image 202, the CPU 101 may interchange the main and navigation images 201 and 203 with the reference and navigation images 202 and 204 for further image adjustment so that the main image 201 is larger than the reference image 202.

The CPU 101 outputs, to the display section 106, display information about display content relating to image adjustment on the screen made based on the display setup information as described above (step ST211).

Even if the number of displays making up the single display space is changed at will by the user, the present embodiment makes it possible to set the layout of display areas of the navigation images, thumbnail images and the text display area according to the layout of the displays so as to ensure that the these images are not divided by a boundary between the displays. This keeps the impact of boundaries between the displays on the visibility to a minimum.

That is, the navigation and thumbnail images appear in such a manner as not to spread across a boundary between the displays, thus preventing these images, which are originally smaller and less sharp than their main images, from being divided by a boundary. This eliminates the inconvenience of part of a subimage, which is already small, extending into the adjacent display and making this portion difficult to see.

Further, the navigation images appear in such a manner as not to spread across a boundary between the displays. Therefore, the navigation frame that appears superimposed on each of the navigation images appears in such a manner as not to spread across a boundary between the displays. This eliminates the inconvenience of the navigation frame becoming difficult to manipulate and see when the spatial conditions (e.g. enlargement ratio and display area) of the main image to be displayed are specified by manipulating the navigation frame in the navigation image.

Still further, the thumbnail images appear in such a manner as not to spread across a boundary between the displays. This eliminates the inconvenience of the thumbnail images becoming difficult to manipulate and see when one of these images is selected to select the main image to be displayed itself.

Still further, the text display area appears in such a manner as not to spread across a boundary between the displays. This eliminates the inconvenience of the text display area becoming larger because of the text display area spreading across the boundary and squeezing the display area of the main image, or this eliminates the difficulty in entering text because of the text display area spreading across the plural displays.

Further, the main and reference images appear so that the boundary between the main and reference images overlaps a boundary between the displays. This contributes to a smaller number of the main and reference images divided by boundaries between the displays, thus eliminating the inconvenience of part of the main and reference images extending into the adjacent display and making this portion difficult to see.

The present disclosure is not limited to the above embodiment and may be modified without departing from the scope of the present disclosure.

For example, the above image adjustment is not limited to the sequence in the flowchart shown in FIG. 5. The sequence in the flowchart shown in FIG. 5 is merely an example. The adjustment of the images in the slide list, that of the image in the text display area, that of the navigation images and that of the main and reference images may be performed in any sequence.

In the above embodiment, on the other hand, the CPU 101 outputs, to the display section 106, display information about display content relating to image adjustment on the screen made based on the display setup information (step ST211). However, the present disclosure is not limited thereto. The CPU 101 may output, in advance, the image based on the initial screen layout information and proceed with the image adjustment after receiving a trigger adapted to initiate the image adjustment issued, for example, by user operation. Further, the CPU 101 may output the image obtained when each of the adjustments of the images, namely, the adjustment of the images in the slide list, that of the image in the text display area, that of the navigation images and that of the main and reference images may be performed in any sequence, is complete. Then, the CPU 101 may proceed with further image adjustment after receiving a trigger adapted to initiate the image adjustment issued, for example, by user operation.

Still further, if a strip or pull-down menu is displayed on the screen, the CPU 101 may further adjust the images based on the display setup information so that the text does not spread across a boundary between the displays.

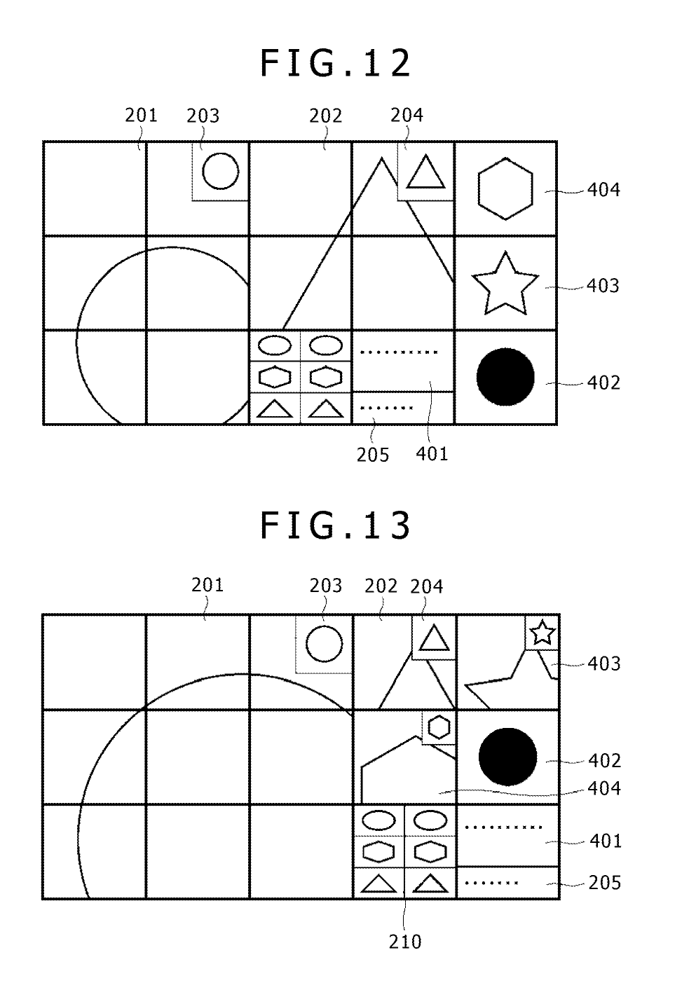

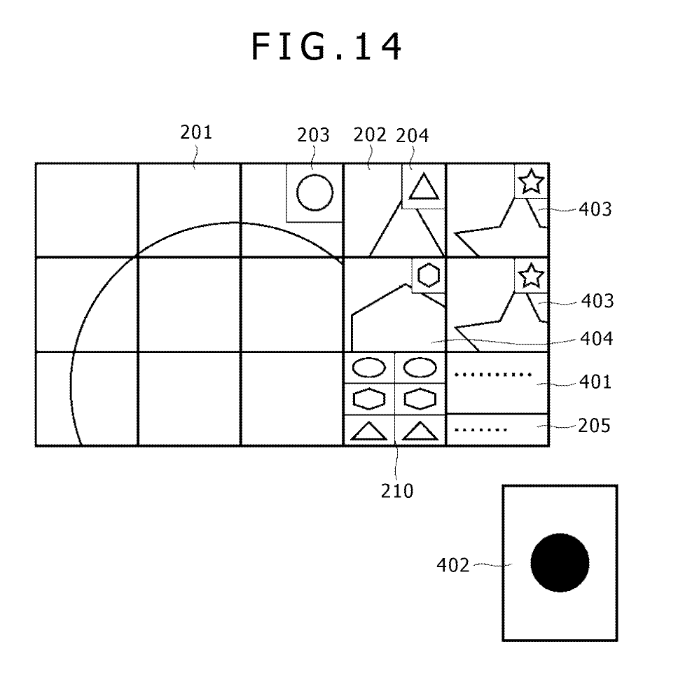

Increasing the number of displays (e.g., 15 displays (three down by five across) increases the area adapted to display the reference images. FIG. 12 illustrates an example in which the number of displayed reference images has been increased. Among reference images are additional information 401 such as patient records, a radiographic image 402, photograph of a block before slicing of a pathological section (gross photograph) 403, another main image 404 and simplified radiographic image. Because a lot of information is necessary for diagnosis, it is only necessary to assign each piece of information to one of the displays if the display area is large enough as in this case. Further, the slide list 210 may be fitted into a single display.

Alternatively, if the number of displays is increased, emphasis may be placed on the display of the main image 201.

Still alternatively, only one reference image (e.g., radiographic image) may be displayed on a specially-sized display. There are cases in which there is a recommended screen quality for the radiographic image 402. Therefore, the radiographic image 402 may be displayed alone on a separate display.

The present disclosure contains subject matter related to that disclosed in Japanese Priority Patent Application JP 2010-268949 filed in the Japan Patent Office on Dec. 2, 2010, the entire content of which is hereby incorporated by reference.

1. An information processor comprising:
a display setup information acquisition section adapted to acquire, as display setup information, information about a layout of a plurality of displays in a display space formed by arranging the plurality of displays adjacently; and
an image adjustment section adapted to adjust, based at least in part on the display setup information, at least either a position or size of a subimage to ensure that the subimage does not spread across a boundary between the displays when an image including a main image and the subimage smaller than the main image is displayed in the display space.

2. The information processor of claim 1, wherein the image adjustment section is configured to display a frame adapted to indicate the display area of the main image in a manner superimposed on the subimage.

3. The information processor of claim 2, wherein when the plurality of main images are displayed side by side, the image adjustment section is configured to adjust, based at least in part on the display setup information, at least either positions or sizes of the plurality of main images so that at least one of boundaries between the plurality of main images overlaps [[the]] boundary between the displays.

4. The information processor of claim 3, wherein when the plurality of subimages, each associated with one of the plurality of main images, are displayed, the image adjustment section is configured to adjust, based at least in part on the display setup information, at least the position or size of the subimage so that one side of at least one of the plurality of subimages overlaps the boundary.

5. The information processor of claim 2, wherein when the plurality of subimages are arranged in a row and displayed as a subimage sequence, the image adjustment section is configured to adjust, based at least in part on the display setup information, at least either the positions or sizes of the plurality of subimages so that at least one of the boundaries between the plurality of subimages overlaps the boundary between the displays.

6. The information processor of claim 2, wherein when a text display area is secured to display text information in the display space, the image adjustment section is configured to adjust, based at least in part on the display setup information, a position of the text display area to ensure that the text display area does not spread across the boundary between the displays.

7. An information processing method comprising:
acquiring information about a layout of a plurality of displays in a display space formed by arranging the plurality of displays adjacently; and
adjusting at least either a position or size of a subimage based at least in part on the display setup information to ensure that the subimage does not spread across a boundary between the displays when an image including a main image and the subimage smaller than the main image is displayed in the display space.

8. A program allowing an information processor to function as:
a display setup information acquisition section adapted to acquire, as display setup information, information about a layout of a plurality of displays in a display space formed by arranging the plurality of displays adjacently; and
an image adjustment section adapted to adjust, based at least in part on the display setup information, at least either a position or size of a subimage to ensure that the subimage does not spread across a boundary between the displays when an image including a main image and the subimage smaller than the main image is displayed in the display space.
